(19) United States
(12) Patent Application Publication
(10) Pub. No.: US 2002/0177024 A1
(43) Pub. Date: Nov. 28, 2002

(54) Metal air electrochemical cell system

(76) Inventors: Ian Shaw, Yorktown, NY (US); Sadeg M. Faris, Pleasantville, NY (US)

Correspondence Address: Reveo, Inc., 85 Executive Blvd., Elmsford, NY, 10523, US

(21) Appl. No.: 10/133,999

(22) Filed: Apr. 24, 2002

Related U.S. Application Data
(60) Provisional application No. 60/286,198, filed on Apr. 24, 2001.

(51) Int. Cl. H01M 12/06; H01M 6/38

(52) U.S. Cl. 429/27; 429/68; 429/113

(57) ABSTRACT

Herein disclosed is a metal air electrochemical cell, which generally includes an anode metal fuel material that may be infused into a container. The container may comprise a metering device, such as a toothpaste-like container, a syringe-like container, a caulking tube type container, a disposable condiment-like container, etc. These metering devices facilitate dispensing of a quantity of the metal fuel paste into a suitable structure generally including a cathode, a separator, and current collectors.

### BACKGROUND OF THE INVENTION

1. Field of the Invention

The present invention relates to metal air electrochemical cells, the more particularly a convenient and disposable metal air electrochemical cell system.

2. Description of the Prior Art

Conventional batteries are packaged with the anode, cathode, and electrolyte within a sealed container. Such packaging is convenient for everyday use, typically in locations and situations where such batteries are easily accessible. However, such batteries typically have limited shelf lives, which retracts from desirability in certain usages, such as emergency situations.

As proposed herein, a metal air electrochemical cell with potentially infinite shelf life is described.

### SUMMARY OF THE INVENTION

The above-discussed and other problems and deficiencies of the prior art are overcome or alleviated by the several apparatus of the present invention, wherein a metal air electrochemical cell is provided. The metal air electrochemical cell includes an anode metal fuel material provided in a container. The container may comprise a metering device, such as a toothpaste-like container, a syringe like container, a caulking tube type container, a disposable condiment-like container, etc. A key feature to all of these devices is the ability to expel a certain quantity of the metal fuel paste into a suitable structure generally including a cathode, a separator, and current collectors.

The above-discussed and other features and advantages of the present invention will be appreciated and understood by those skilled in the art from the following detailed description and drawings.

### BRIEF DESCRIPTION OF THE DRAWINGS

FIG. 1 is a schematic of an electrochemical cell system;

FIG. 2 depicts a system for generating electrochemical energy;

FIG. 3 depicts another system for generating electrochemical energy;

FIG. 4 depicts a device incorporating a system for generating electrochemical energy;

FIG. 5 shows an example of a device that may be used in conjunction with a system for generating electrochemical energy; and

FIG. 6 is a schematic of a system for generating electrochemical energy employing multiple electrochemical cells.

### DETAILED DESCRIPTION OF THE ILLUSTRATIVE EMBODIMENTS

Herein disclosed is a metal air electrochemical cell, which generally includes an anode metal fuel material that may be infused into a container. The container may comprise a metering device, such as a toothpaste-like container, a syringe-like container, a caulking tube type container, a disposable condiment-like container, etc. These metering devices facilitate dispensing of a quantity of the metal fuel paste into a suitable structure generally including a cathode, a separator, and current collectors.

Referring now to the drawings, illustrative embodiments of the present invention will be described. For clarity of the description, like features shown in the figures shall be indicated with like reference numerals and similar features as shown in alternative embodiments shall be indicated with similar reference numerals.

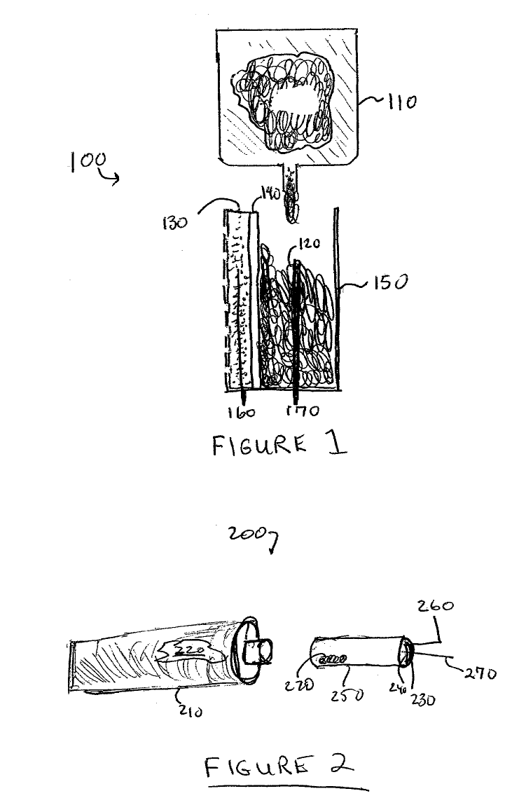

Referring now to FIG. 1, a system 100 is depicted. System 100 is a metal air electrochemical cell which is activated upon inclusion of metal fuel into a suitable cathode containing structure. The system 100 generally includes a container 110 including a quantity of metal fuel paste 120. The container 110 is preferably a metering device, which is capable of providing a quantity of metal fuel with, for example, application of a force to the container. For example, the force may be applied across the body of the container 110, at an end of the container, or a combination thereof. Such containers include, but not limited to, metering devices, such as collapsible or non-collapsible toothpaste-like containers, syringe-like container, caulking tube type containers, disposable condiment-like containers, and the like.

The metal fuel is injected into a cathode structure 150, which includes a cathode 130, a separator 140, a cathode current collector 160, and an anode current collector 170. The cathode structure 150 may be any suitable shape to react with the fuel paste 120.

Oxygen from the air or another source is used as the reactant for the cathode 130. When oxygen reaches the reaction sites within the cathode 130, it is converted into hydroxyl ions together with water. At the same time, electrons are released to flow as electricity in an external circuit across the current collectors 160, 170. The hydroxyl travels through the separator 140 to reach the anode material 120 (which has been previously injected into the structure 150). When hydroxyl reaches the anode (in the case of a fuel 120 comprising, for example, zinc), zinc hydroxide is formed on the surface of the zinc. Zinc hydroxide decomposes to zinc oxide and releases water back to the alkaline solution. The reaction is thus completed.

The anode reaction is:

Zn+4OH⁻→Zn(OH)₄²⁻+2e (1)

Zn(OH)₄²⁻→ZnO+H₂O+2OH⁻ (2)

The cathode reaction is:

½O₂+H₂O+2e→2OH⁻ (3)

Thus, the overall cell reaction is:

Zn+½O₂→ZnO (4)

The anode paste generally comprises a metal constituent and an ionic conducting medium. In certain embodiments, the ionic conducting medium comprises an electrolyte, such as an aqueous electrolyte, and a gelling agent. Preferably, the formulation optimizes ion conduction rate, density, and overall depth of discharge, while being stable (e.g., minimizes or eliminates settling during storage and/or operation), mobile, and pumpable. In certain embodiments, the paste has a viscosity of about 0.1 Pa s to about 50,000 Pa s, preferably about 10 Pa s to about 20,000 Pa s, and more preferably about 100 Pa s to about 2,000 Pa s.

The metal constituent may comprise mainly oxidizable metals such as zinc, calcium, lithium, magnesium, ferrous metals, aluminum, and combinations and alloys comprising at least one of the foregoing metals. These metals may also be alloyed with constituents including, but not limited to, bismuth, calcium, magnesium, aluminum, indium, lead, mercury, gallium, tin, cadmium, germanium, antimony, selenium, thallium, or combinations comprising at least one of the foregoing constituents. In certain embodiments, the metal constituent of the anode comprises zinc or combinations and alloys comprising zinc.

The metal constituent may be provided in the form of powder, dust, granules, flakes, needles, pellets, fibers, or other particles. In certain embodiments, granule metal, particularly zinc alloy metal, is provided having mesh sizes from about 10 to about 325, preferably about 20 to about 300, and more preferably about 30 to about 200.

The electrolyte generally comprises sufficient ion conducting material to allow ionic conduction between the metal anode and the cathode. The electrolyte generally comprises ionic conducting materials such as KOH, NaOH, LiOH, other materials, or a combination comprising at least one of the foregoing electrolyte media. Particularly, the electrolyte may comprise aqueous electrolytes having a concentration of about 5% ionic conducting materials to about 55% ionic conducting materials, preferably about 10% ionic conducting materials to about 50% ionic conducting materials, and more preferably about 30% ionic conducting materials to about 45% ionic conducting materials.

The gelling agent may be any suitable gelling agent in sufficient quantity to provide the desired consistency of the paste. The percentage of gelling agent is generally about 0.5% to about 20%, preferably about 1% to about 10%, more preferably about 1% to about 5%. The gelling agent may be a crosslinked polyacrylic acid (PAA), such as the Carbopol® family of crosslinked polyacrylic acids (e.g., Carbopol® 675) available from BF Goodrich Company, Charlotte, N.C., and potassium and sodium salts of polyacrylic acid or polymethyl acrylic acid; carboxymethyl cellulose (CMC), such as those available from Aldrich Chemical Co., Inc., Milwaukee, Wis.; hydroxypropylmethyl cellulose; polyvinyl alcohol (PVA); poly(ethylene oxide) (PEO); polybutylvinyl alcohol (PBVA); natural gum; Polygel 4P (available from Aldrich); grafted starch water, such as Waterlock® A221, available from Grain Processing Corp., Muscatine, Iowa); combinations comprising at least one of the foregoing gelling agents; and the like.

The anode current collector 170 is formed of any electrically conductive material capable of providing electrical conductivity and optionally capable of providing support to the fuel pastes 120 and/or the structure 150. The current collector may be in the form of a mesh, porous plate, metal foam, strip, nail, wire, foil, plate, or other suitable structure. The current collector may be formed of various electrically conductive materials including, but not limited to, copper, plated ferrous metals such as stainless steel, tin, brass, lead, silver, and the like, and combinations and alloys comprising at least one of the foregoing materials.

Optional additives may be provided to prevent corrosion. Suitable additives include, but are not limited to indium oxide; zinc oxide, EDTA, surfactants such as sodium stearate, potassium Lauryl sulfate, Triton® X-400 (available from Union Carbide Chemical & Plastics Technology Corp., Danbury, Conn.), and other surfactants; the like; and derivatives, combinations and mixtures comprising at least one of the foregoing additive materials. However, one of skill in the art will determine that other additive materials may be used.

Cathode 130 may be a conventional air diffusion cathode, for example generally comprising an active constituent and a carbon substrate, along with suitable connecting structures, such as a current collector. An exemplary air cathode is disclosed in copending, commonly assigned U.S. patent application Ser. No. 09/415,449, entitled “Electrochemical Electrode For Fuel Cell”, to Wayne Yao and Tsepin Tsai, filed on Oct. 8, 1999, which is incorporated herein by reference in its entirety. Other air cathodes may instead be used, however, depending on the performance capabilities thereof, as will be obvious to those of skill in the art.

The carbon used is preferably be chemically inert to the electrochemical cell environment and may be provided in various forms including, but not limited to, carbon flake, graphite, other high surface area carbon materials, or combinations comprising at least one of the foregoing carbon forms. The cathode current collector may be any electrically conductive material capable of providing electrical conductivity and optionally capable of providing support to the cathode 14. The current collector may be in the form of a mesh, porous plate, metal foam, strip, wire, foil, plate, or other suitable structure. In certain embodiments, the current collector is porous to minimize oxygen flow obstruction. The current collector may be formed of various electrically conductive materials including, but not limited to, nickel. nickel plated ferrous metals such as stainless steel, and the like, and combinations and alloys comprising at least one of the foregoing materials. Suitable current collectors include porous metal such as nickel foam metal.

The active constituent is generally a suitable catalyst material to facilitate oxygen reaction at the cathode 130. The catalyst material is generally provided in an amount suitable to facilitate oxygen reaction at the cathode 130. Suitable catalyst materials include, but are not limited to: manganese and its compounds, cobalt and its compounds, platinum and its compounds, and combinations comprising at least one of the foregoing catalyst materials.

To electrically isolate the fuel 120 from the cathode 130, the separator 140 is provided between the electrodes. The separator 140 is disposed in ionic communication with the cathode 130. When sufficient fuel 120 is injected in the structure 150, ionic communication between the fuel 120 and the cathode 130 via the separator 140 is established. Separator 140 may be any commercially available separator capable of electrically isolating the fuel 120 and the cathode 130, while allowing sufficient ionic transport between the fuel 120 and the cathode 130. Preferably, the separator is flexible, to accommodate electrochemical expansion and contraction of the cell components, and chemically inert to the cell chemicals. Suitable separators are provided in forms including, but not limited to, woven, non-woven, porous (such as microporous or nanoporous), cellular, polymer sheets, and the like. Materials for the separator include, but are not limited to, polyolefin (e.g., Gelgard® commercially available from Celgard LLC, Charlotte, N.C.), polyvinyl alcohol (PVA), cellulose (e.g., cellophane, cellulose acetate, and the like), polyamide (e.g., nylon), fluorocarbon-type resins (e.g., the Nafion® family of resins which have sulfonic acid group functionality, commercially available from DuPont Chemicals, Wilmington, Del.), filter paper, and combinations comprising at least one of the foregoing materials. The separator may also comprise additives and/or coatings such as acrylic compounds and the like to make them more wettable and permeable to the electrolyte. Further, the separator 140 may comprise a solid-state membrane, such as described in copending, commonly assigned: U.S. Pat. No. 6,183,914, entitled “Polymer-based Hydroxide Conducting Membranes”, to Wayne Yao, Tsepin Tsai, Yuen-Ming Chang, and Muguo Chen, filed on Sep. 17, 1998, which is incorporated herein by reference in its entirety; U.S. patent application Ser. No. 09/259,068, entitled “Solid Gel Membrane”, to Tsepin Tsai, Muguo Chen, Wayne Yao, Yuen-Ming Chang, Lin-Feng Li, and Tom Karen, filed on Feb. 26, 1999, which is incorporated herein by reference in its entirety; and U.S. patent application Ser. No. 09/482,126, entitled “Solid Gel Membrane Separator In Rechargeable Electrochemical Cells”, to Muguo Chen, Lin-Feng Li, and Tsepin Tsai, filed on Jan. 11, 2000, which is incorporated herein by reference in its entirety.

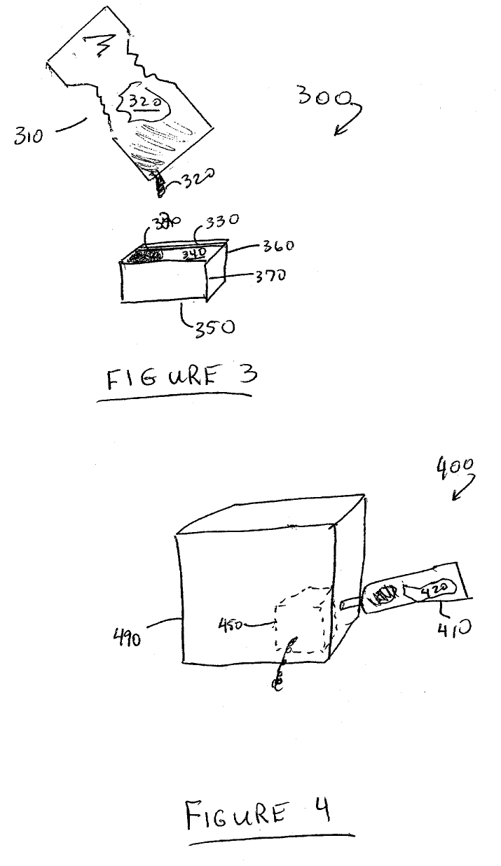

Referring now to FIG. 2, another embodiment of a metal air electrochemical cell described herein is provided. The system 200 includes a container or tube 210 comprising a quantity of metal fuel paste 220. The tube 210 is preferably formed with a suitable sealing structure, such as a cap or a sealed end which may be, for example, cut off. To activate the electrochemical cell, a quantity of fuel 220 from the tube 210 is, for example, squeezed into a structure 250. The structure 250 is generally cylindrical in shape, however, the shape may vary depending on the particular needs. The volume of the container 210 may vary, depending on the particular needs. The volume may be generally between less than about 1 cc and to whatever maximum volume is needed, depending on the particular application and the quantity of material that is practical to carry and dispense from the container. For example, large tubes may be provided which can be squeezed by an external mechanical device, or which may be squeezed by application of a large enough force, for example, by a person's hands. Furthermore, higher forces may ber required, for example, which may require an individual to firmly step on the tube. In one preferred embodiment, and, for example an emergency application, the tube 210 is a relatively small size, which is convenient to carry, for example, in a backpack for emergency applications.

The volume of the structure 250 generally varies depending on the capacity required of the electrochemical cell. For example, the volume of the structure 250 may be dimensioned to similar to corresponding capacity conventional batteries (e.g., AAAA., AAA, AA, C, D, etc.).

Similar to the system described above with respect to system 100, structure 250 includes a cathode 230, a separator 240, and suitable current collectors 260, 270.

One end of the structure 250 is generally open in to allow for injection of the fuel paste 220. For injection of the fuel paste 220, is not necessary that the end be sealed to the atmosphere, nor is any other special cap structure required. The opposing end of the structure 250 may be closed or may be open. In applications where the end of the structure 250 is closed, a permanent or removable cap may be provided. A removable cap will allow injection of more metal fuel paste 220, whereby the discharged paste is expelled. In certain embodiment, where the end of the structure 250 is open, when the power output from the electrochemical cell decreases, additional fuel material 220 can be injected into the structure 250 to provide for substantially continuous discharge.

The structure 250 may comprise, for example, a plastic, pulpous, metal, ceramic, or any other suitable material capable of providing structural integrity to system. To allow for activation of the cathode 230, the structure 250 is preferably porous or has other suitable openings or venting structures to allow air to contact the cathode 230.

Referring now to FIG. 3, another embodiment of a system 300 is schematically depicted. The system 300 comprises a container 300 and having metal fuel 320 therein, which maybe injected into a structure 350, which includes a cathode 330, a separator 340, and suitable current collectors 360, 370, generally as described above. The structure 350 may be prismatic in shape, for example. In certain embodiments, a second cathode 330′ may also be formed in the structure 350, which allows for increased current output and greater depth of discharge, particularly in rectangular shaped structures 350.

Referring now to FIG. 4, a system 400 is depicted, which includes an electrical consuming device 490. The electrical consuming device 490 includes a structure 450 therein similar and function of the structures 150, 250, 350 described above, except that the structure is disposed within the device 490. Thus, to activate the device, fuel 420 may be injected from a container 410 in the structure 450. When the fuel is discharged, it may be removed and replaced. In certain embodiments where the structure 450 includes an open outlet port, the material may be discharged when fresh material 420 is provided from the container 410. The device 490 may include any electrical consuming device, such as a radio, emergency beacon, lamp, personal digital assistant, charger (e.g., for a device such as a laptop computer, wireless phone, etc.), or any other electrical consuming device.

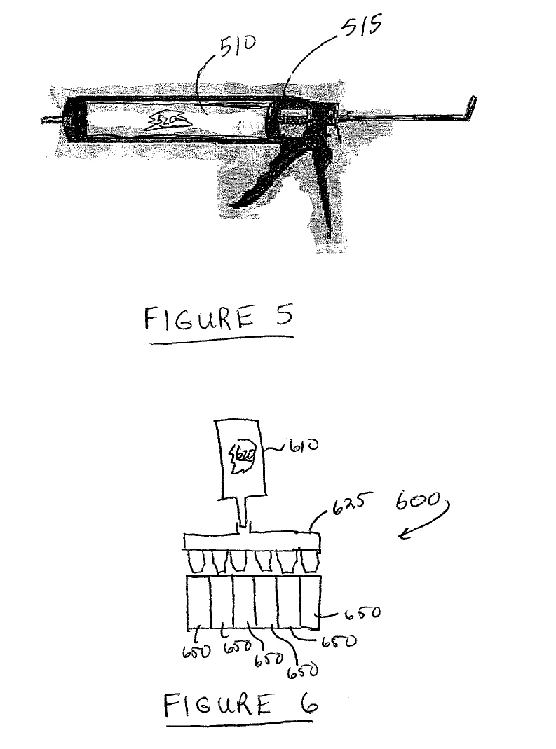

Referring now to FIG. 5, a device 515 is depicted, which assists in providing the force to discharge metal fuel 520 from a container 510. The device 515 may comprise, for example, a caulking gun type device, for example, including a suitable structure for holding the container 510, and further a suitable mechanism such as a trigger activated mechanism for applying a forced to the container 510 to inject the material 520 into a suitable structure (not shown).

In addition to using a single electrochemical cell, a plurality electrochemical cells can be arranged in various configurations to provide various output voltages. For example, in the case where the metal air fuel paste is for example, with a metal air fuel paste comprises the zinc based material, the output voltage may vary between about 1 V and 1.2 V. Accordingly, the plurality of these can be arranged together to provide 6, 12, or other suitable output voltage needs.

Referring now to FIG. 6, a system 600 includes a plurality of structures 650, generally similar to those described above, which may be housed within a suitable container, or otherwise supported. A quantity of fuel paste 620 may be injected directly into each structure 650 individually from a metering container 610, or alternatively may be injected via a manifold 625 to allow for a single injection step to inject the fuel 620 into the plurality of structures 650.

With the systems described herein, a convenient and portable combination of a container and a cathode containing structure are capable of generating electrical power on demand. Since the metal fuel paste is in a container, rather than in the cell in ionic contact with the electrolyte and/or the cathode. Further, corrosion and/or oxidation of the metal fuel paste is minimized or eliminated. Therefore, the metal fuel paste may have very long lifetimes, on the order of one or more decades.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. A system for producing electrical power comprising:
a metering container comprising a quantity of metal fuel paste; and
a structure for containing a cathode, a separator, and anode current collector, and a cathode current collector, wherein upon metering of the metal fuel paste from the metering container into the structure, electrochemical reaction is initiated which provides voltage across the current collectors.

2. The system as in claim 1, wherein the metering container comprises a collapsible container.

3. The system as in claim 1, wherein the metering container comprises a syringe-like container.

4. A kit for producing electrical power comprising:
a metering container comprising a quantity of metal fuel paste; and
a structure for containing a cathode, a separator, and anode current collector, and a cathode current collector, wherein upon metering of the metal fuel paste from the metering container into the structure, electrochemical reaction is initiated which provides voltage across the current collectors.

5. A kit for producing electrical power on demand comprising:
a structure for containing a cathode, a separator, and anode current collector, and a cathode current collector, wherein upon metering of the metal fuel paste from a metering container into the structure, electrochemical reaction is initiated which provides voltage across the current collectors.
